(19) United States
(12) Patent Application Publication
(10) Pub. No.: US 2019/0129777 A1
(43) Pub. Date: May 2, 2019

(54) METHOD, SYSTEM, AND APPARATUS FOR AN IMPROVED MEMORY ERROR PREDICTION SCHEME

(71) Applicant: Intel Corporation, Santa Clara, CA (US)

(72) Inventor: Thanunathan Rangarajan, Bangalore (IN)

(21) Appl. No.: 16/082,512

(22) PCT Filed: Feb. 16, 2017
(86) PCT No.: PCT/US2017/018173

§ 371 Date: Sep. 5, 2018

(30) Foreign Application Priority Data
Mar. 31, 2016 (IN) 201641011343

(51) Int. Cl. G06F 11/07; G06F 11/10

(52) U.S. Cl. CPC G06F 11/076; G06F 11/1076; G06F 11/0793; G06F 11/073

(57) ABSTRACT

Method, system, and apparatus for predicting imminent memory failures based on one or more adverse conditions being subjected to the memory. One embodiment of a method comprises: tracking one or more corrected memory errors (CEs) in a memory; tracking one or more generated tokens, wherein the tokens are being generated at an initial rate; detecting one or more adverse conditions being subjected to the memory and responsive to the detection, reduce the rate at which the tokens are being generated; decrementing the tracked CEs based on a reoccurring leak timer, wherein upon each expiration of the reoccurring leak timer, the tracked CEs is decremented by one so long as there is at least one tracked token; reducing the tracked tokens by one in response to the decrement of the tracked CEs; and triggering a CE overflow signal upon detecting a count of the tracked CEs exceeding an overflow limit.

### BACKGROUND INFORMATION

Memory is among the most vulnerable of platform components. Major datacenters report that on average nearly 8% of all installed memory DIMMs in their datacenters are affected by errors. Memory failures can have devastating impacts on computer system performance, ranging from sudden downtime to unrecoverable data loss. As such, a growing number of datacenter and cloud service providers are looking for ways to minimize and/or prevent memory-related system failures. Thus, there exists a need for an improved memory failure prediction scheme that can proactively and accurately identify imminent memory hardware failures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a block diagram illustrating a hardware platform utilizing the hardware predictor in accordance with an embodiment of the present invention.

FIG. 2 is a schematic diagram of the hardware predictor according to an embodiment.

FIG. 3 is a flow diagram illustrating corrected errors (CE) overflow detection in the token bucket according to one embodiment.

FIG. 4 is a flow diagram illustrating CE leakage from the token bucket according to an embodiment.

FIG. 5A a flow diagram illustrating token replenishment according to an embodiment.

FIG. 5B a flow diagram illustrating token replenishment according to another embodiment.

FIG. 6A is a block diagram illustrating both an exemplary in-order pipeline and an exemplary register renaming, out-of-order issue/execution pipeline according to embodiments of the invention;

FIG. 6B is a block diagram illustrating both an exemplary embodiment of an in-order architecture core and an exemplary register renaming, out-of-order issue/execution architecture core to be included in a processor according to embodiments of the invention;

FIG. 7 is a block diagram of a single core processor and a multicore processor with integrated memory controller and graphics according to embodiments of the invention;

FIG. 8 illustrates a block diagram of a system in accordance with one embodiment of the present invention;

FIG. 9 illustrates a block diagram of a second system in accordance with an embodiment of the present invention;

FIG. 10 illustrates a block diagram of a third system in accordance with an embodiment of the present invention;

FIG. 11 illustrates a block diagram of a system on a chip (SoC) in accordance with an embodiment of the present invention;

FIG. 12 illustrates a block diagram contrasting the use of a software instruction converter to convert binary instructions in a source instruction set to binary instructions in a target instruction set according to embodiments of the invention;

### DETAILED DESCRIPTION

Embodiments implementing a hardware predictor for predicting imminent memory hardware failures are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For clarity, individual components in the Figures herein may be referred to by their labels in the Figures, rather than by a particular reference number.

A reliable memory failure prediction solution may be devised based on several key observations about memory errors:
1. Correctable memory errors have a strong tendency to degenerate into uncorrectable memory errors. The presence of correctable memory errors may increase the probability of encountering uncorrectable memory errors by as much as 400%.
2. Memory errors are closely tied to memory utilization. As utilization increases, more stress is placed on the DRAMs which leads to a higher likelihood of memory failures. Moreover, high utilization also increases the opportunity for discovering defects in memory. The correctable error rate at high utilization is about 2-3 times higher than that of low utilization.
3. Memory errors are often times caused by low signal integrity that manifests as suboptimal eyes on the DDR links. Suboptimal DDR eyes tend to give rise to packet errors.
4. High ambient temperature accelerates memory cell aging.

Some technology providers, such as Intel Corporation of Santa Clara, Calif., have begun addressing the memory error degeneration problem by tracking correctable error (CE) rates and reporting excursions of CE rates beyond a certain threshold. This is based on the observation that if too many correctable errors are found in a particular DIMM, then there is a strong likelihood of hard errors present on that particular DIMM, leading to a permanent failure in the near future.

A common method for determining correctable error rates is the leaky bucket algorithm. In a leaky bucket algorithm, detected CEs are first stored in a bucket and then slowly leak out at a constant rate. An error burst occurring within a given leak time window, such that the detected CEs arrive at the bucket faster than they leak from the bucket, would cause the bucket to overflow. A bucket overflow is an indication that the error rate is too high and the memory experiencing the high error rate is like to fail in the immediate future. Upon such occurrence, the memory controller would report the overflow event to the appropriate hardware and/or software components to trigger error handling and/or fault isolation measures. While the leaky bucket algorithm provides some predictability with respect to memory failures associated with high volume of correctable errors, it does not take into account other factors that also contribute to such failures. Factors such as heavy utilization, sub-optimal signal integrity, and high ambient temperature noted above.

The present invention introduces a modified error prediction scheme that is sensitive to the effects of memory utilization, signal integrity, and ambient temperature, thereby providing a more comprehensive analysis in predicting potential memory failures. This improved scheme will help meet the needs of datacenters and cloud service providers that require early detection of failing memory issues to ensure high data quality and service continuity. In the improved scheme, a token bucket in a predictor core of the memory controller stores corrected ECC errors (CEs). The token bucket also stores incoming tokens that arrive at a rate that is modulated by the detection of one of more of the following adverse conditions, or adversities:
The observed aggregated utilization exceeds a programmable threshold for a time window of interest
The DDR signal eye deteriorated below a certain wireframe for a time window of interest
DIMM temperature excursions above a programmable threshold for the time window of interest, after accounting for hysteresis

Similar to a standard leaky bucket algorithm, the token bucket in the predictor core drains or leaks stored CEs at a constant rate. However, the CE is permitted to leak only when the token bucket has at least one token present. Thus, the CE leakage rate is effectively controlled by the token arrival rate. Initially, the token arrival rate is set to be the same as the CE leakage rate such that a token is always available whenever a CE is to be leaked from the bucket. This is the default behavior which is equivalent to the standard leaky bucket algorithm.

From there, whenever one or more adverse conditions are detected, the token arrival rate is decreased accordingly. As the token arrival rate falls below the CE leakage rate, tokens will start to run out. Once the tokens in the token bucket are depleted, CEs will start to accumulate. Thus, the presence of one or more adverse conditions will lead to an accumulation of CEs in the token bucket and thereby increase the speed and the likelihood of a bucket overflow. When the token bucket overflows, an error signal or message, such as a Corrected Machine Check Interrupt (CMCI) or a Machine Check Exception (MCE), is generated to trigger error handling and or/other reporting mechanisms in the system. In the absence of any adverse condition, the token arrival rate returns to the initial rate, which in turn restores the token bucket back to the initial CE leakage rate.

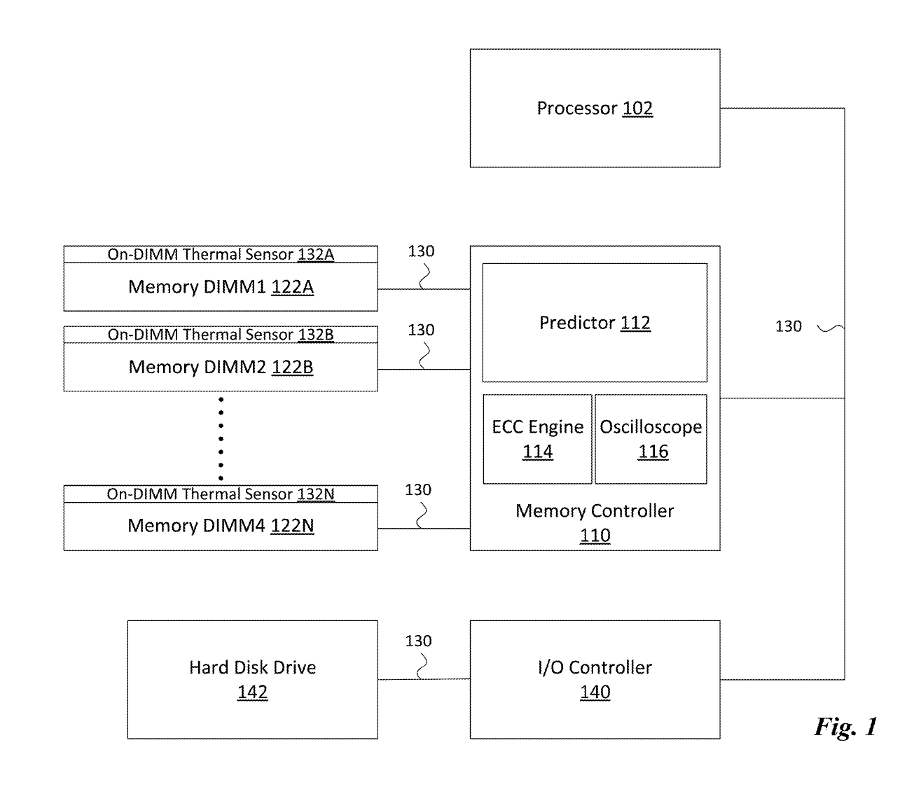

FIG. 1 is a block diagram illustrating a hardware platform utilizing the hardware predictor in accordance with an embodiment of the present invention. The hardware platform comprises a processor 102 coupled to a memory controller 110 and an I/O controller 140 through bus 130. The memory controller 110 further comprises a predictor 112, error correction code (ECC) engine 110, and an oscilloscope 116. One or more memory DIMMs 122A-122N, each comprising an on-DIMM thermal sensor (ODTS) 132A-132N, is communicatively coupled to the memory controller 110. The hardware platform may also comprise one or more hard disk drive 142 as well as other I/O devices (not shown) that are communicatively coupled to the I/O controller 140. While some hardware components are shown as individual components in FIG. 1, they may be part of another hardware component according other embodiments. For instance, the memory controller 110 may be part of the processor 102. Conversely, while some hardware components are shown as included in or as part of another hardware component, they may be separate components according to at least some embodiments. For instance, the ECC Engine 114 and the Oscilloscope 116 may be separate from the memory controller 110, rather than part of it. In one embodiment, the ECC Engine 114 is a hardware circuitry.

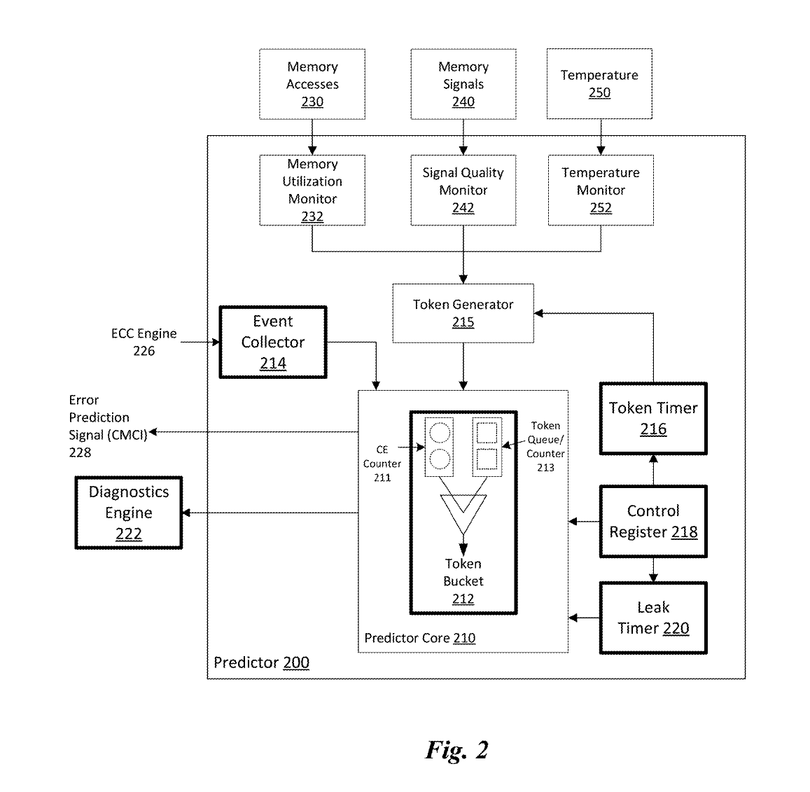

FIG. 2 is a schematic diagram showing exemplary hardware predictor implementations according to one embodiment. The predictor 200 comprises a predictor core 210, an event collector 214, a control register (TB CTRL) 218, a token timer (TBTIM) 216, a leak timer (LBTIM) 220, a token generator 215, and one or more adverse condition detectors. Examples of adverse condition detector include memory utilization monitor 232, signal quality monitor 242, and temperature monitor 252

The predictor core 210 includes one or more token buckets 212. The token buckets may be implemented as one per memory rank, one per memory channel, or any other suitable arrangement. Each token bucket includes a corrected error counter (CE counter) 211 and a token counter 213. The CE counter 211 is used to track the number of corrected memory errors (CEs) detected by the event collector 214 and the token counter 213 is used to track the number of tokens generated by the token generator 264.

The event collector 214 interfaces with the Error Correction Code (ECC) engine 226 to collect corrected errors. In some embodiments, the event collector 214 may also communicate with the DDR interface (not shown) to collect corrected CRC/parity errors on the DDR links. According to at least some embodiments, the errors collected from both the ECC engine and the DDR interface are collectively treated as corrected errors. Each time the event collect 214 receives a corrected error, it notifies the predictor core and the CE counter 211 is responsively incremented. In at least one embodiment, the ECC Engine 226 is a hardware circuitry.

The control register 218 includes configurable fields such as leak rate (LRATE), token rate (TRATE), and/or token rate multiplier (TMUL) that are used by components such as the token timer (TBTIM) 216 and the leak timer (LBTIM) 220 to adjust timer settings.

The token timer 216 is communicatively coupled to the token generator 215 and the control register 218. It is a self-repeating internal timer that expires at a programmable fixed rate. At each expiration of the token timer 216, the token generator 215 determines whether or not to add token(s) to the token bucket. For instance, a token may be added to a token queue or a token counter may be incremented. The token timer is programmed by setting the token rate (TRATE) in the control register 218, such as modifying an attribute TB_CTRL.TRATE.TBTIM.

The leak timer (LBTIM) 220 is another self-repeating internal timer that expires at a different programmable fixed rate. In contrast with the token timer 216, the leak timer 220 controls the rate at which CEs are leaked from the token bucket. As noted above, every CE to be leaked from the token bucket requires a token. Thus, assuming there is sufficient tokens available in the token bucket, as indicated by the token queue or counter, upon every expiration of the leak timer, the CE counter is decremented by one. According to an embodiment, the leak timer is programmed by setting the leak rate (LRATE) in the control register 218. Specifically, an attribute, such as TB_CTRL.LRATE.LBTIM, can be configured to specify the rate at which the CE counter is reduced.

The memory utilization monitor 232 is communicatively coupled to receive and record memory utilization data, such as memory accesses. In certain embodiments, the memory utilization monitor 232 also calculates and tracks the average memory utilization, such as the number of memory transactions made or memory bandwidth consumed over a given time period. The time period, or Utilization_Window, over which the memory utilization is measured or calculated is specified by the TB_CTRL.TRATE and TB_CTRL.TMUL fields stored in the control register 218, such that:

Utilization_Window=TB_CTRL.TRATE×TB_CTRL.TMUL

In one embodiment, the memory utilization monitor 232, upon detecting that the memory utilization has exceeded a pre-determined threshold, sends a signal to the token generator 215. In other embodiments, the memory utilization monitor simply relays the memory utilization data it had collected and recorded to the token generator 215 and/or the predictor core 210.

The signal quality monitor 242 is communicatively coupled to receive and record memory signals. In some embodiments, the signal quality monitor 242 is coupled to one or more built-in or on-die oscilloscope to measure the signal eye of read and write signals to the memory DIMMs and responsively calculate the amount of distortion in the signal eye. According to an embodiment, upon detecting that a measured signal eye exhibit eye distortion over a certain threshold, the signal quality monitor 242 sends a signal to the token generator 215. Alternatively, the signal quality monitor simply provides the collected and recorded memory signal data to the token generator 215 and/or the predictor core 210.

The temperature monitor 252 is communicatively coupled to receive and record temperature data from one or more temperature sensors. The temperature sensors may include on-DIMM temperature sensors (ODTS) implemented on each memory DIMM. According to an embodiment, the temperature monitor 252 maintains a moving average of maximum DIMM temperature over the time window specified by TBVCTRL.TRATE, or a multiple thereof as determined by TBVCTRL.TMUL. Upon detecting that the average memory DIMM temperature exceeds a pre-determined threshold, the temperature sensor 252 sends a signal to the token generator 215 according to an embodiment. In other embodiments, the temperature monitor provides the corrected and recorded temperature information to the token generator 215 and/or the predictor core 210.

As mentioned above, the hardware memory predictor described herein is sensitive to adverse conditions such as memory over-utilization, sub-optimal memory signal, and high ambient temperatures through controlling the rate at which tokens are replenished in the token bucket. According to an embodiment, the token arrival rate R(n) is modulated according to the following formula (A):

$$R ( n ) = \frac{λ}{1 + < U ( n ) > + < T ( n ) > + < E ( n ) >} \qquad ( A )$$

U(n) is the % aggregate memory transaction count, T(n) is the % average temperature excursions and E(n) is the % measurements of DDR eye that pertained to eye distortion. Each of these parameters is accumulated and between the n-1^{th} and n^{th} intervals of the moving average window:

Window=TBVCTRL.TRATE×TB_CTRL.TMUL

The rate of accumulation (TB_CTRL.TMUL) can be varied to control the weight and sensitivity of these parameters. λ is the leak rate, programmable by changing TB_CTRL.RATE in the control register 218. The <> notation denotes the following formula (B):

$$< X >= \{ \begin{matrix}\frac{X - {X}_{th}}{{X}_{th}} , & if X > {X}_{th} \\ 0 , & otherwise\end{matrix} \qquad ( B )$$

According to formula (A), the token bucket in the hardware memory predictor defaults to a simple leaky bucket when there are no adversities (i.e., <U(n)>=<T(n)>=<E(n)>=0 and thus R(n)=λ). However, when any of the three adversities are observed, the token arrival rate R(n) decreases and thereby the replenishment of tokens is delayed. As noted above, since each CE to be leaked from the token bucket requires a token, when the token in the token queue or counter is depleted, CEs starts to accumulate in token bucket which increases the likelihood of a bucket overflow event. In some embodiments, a probabilistic token insertion scheme is employed in which tokens are added to the token queue or counter at sampling interval n, as controlled by the token timer, with a probability based on R(n).

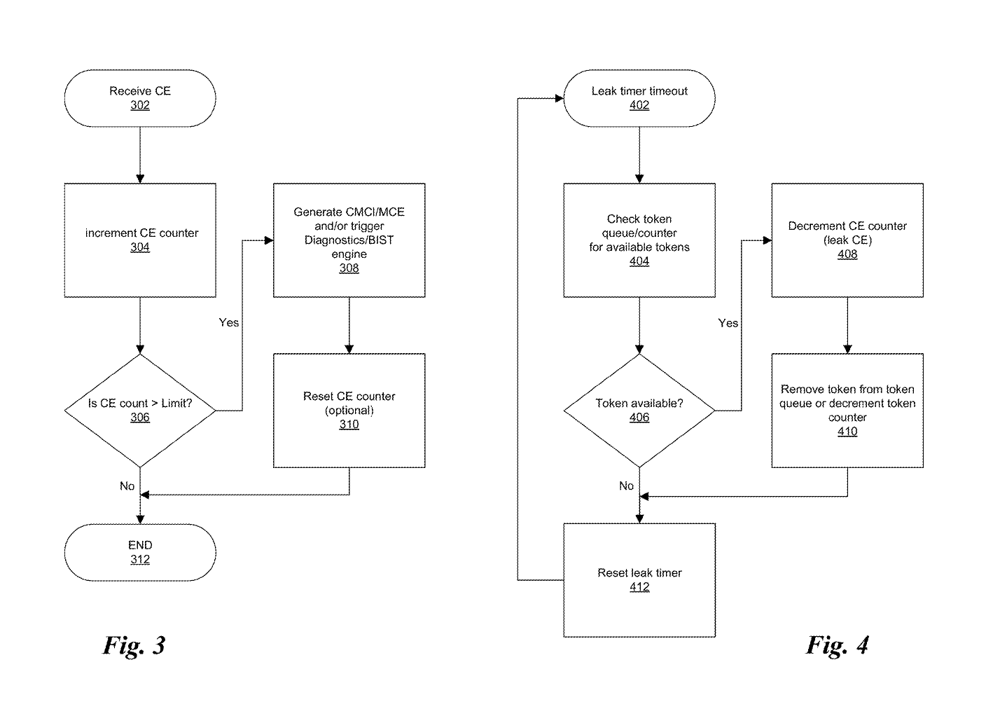

FIG. 3 is a flow diagram illustrating CE overflow detection according to one embodiment. A CE is received by the event collector 214 at block 302. Responsive to the event collector receiving the CE, the predictor core 210 increments the CE counter 211 at block 304. Next, the new CE count tracked by the CE counter is checked against a pre-programmed CE limit in block 306. If the CE count is below the CE limit, CE overflow detection ends at block 312. If, however, at block 306 the CE count exceeds the CE limit, the predictor core 210 responsively generates an error signal such as a Corrected Machine Check Interrupt (CMCI) or a Machine Check Exception (MCE) at block 308 to notify or warn against the likelihood imminent failure of the monitored memory DIMM so that appropriate measures can be taken. Optionally, in addition to triggering the CMCl/MCE signal, the predictor core 210 also signals the appropriate diagnostic engine and/or a built-in self-test (BIST) system to further investigate potential issues in the memory system. According to some embodiments, the diagnostic engine and BIST system are hardware circuitries.

After the appropriate actions are taken by the predictor core 210, the CE counter automatically resets according to an embodiment. In another embodiment, resetting of the CE counter is dependent upon the diagnostic results from the diagnostic engine or BIST system.

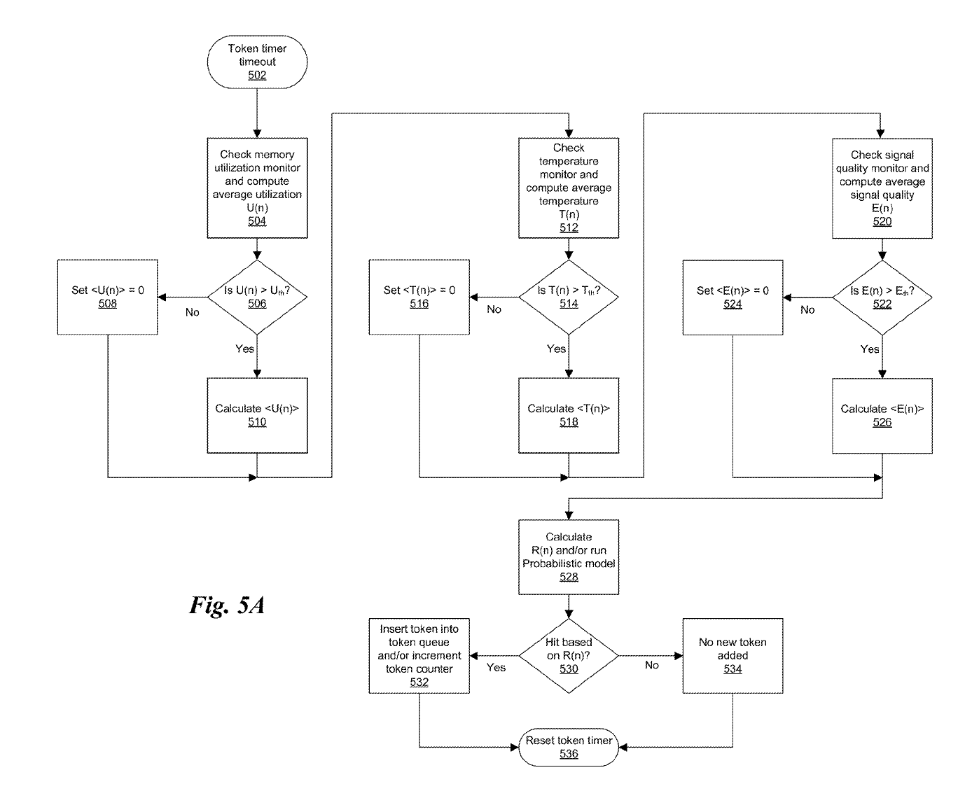

FIG. 4 is a flow diagram illustrating an embodiment of a method in which CEs are leaked from the token bucket. At block 402, an expiration of leak timer 220 is detected. In response to the detection, at block 404, the predictor core 210 checks the token queue or token counter 213 for available tokens. A determination is made at block 406 as to whether at least one token is available. If there is no token available, no CE is leaked from the token bucket and the leak timer 220 resets at block 412. On the other hand, if a token is available at block 406, the CE counter is decremented by one at block 408 which represents that one CE has “leaked” from the bucket. Responsive to the CE leakage, at block 410, the token counter is decremented by one to account for the used token. Next, the leak timer 220 reset at block 412. While in the embodiment described here, the ratio between the CE leakage and the token is 1 to 1, other ratios may be used to allow additional leak rate control and/or adjustment. For instance one token may allow multiple CE to leak from the token bucket.

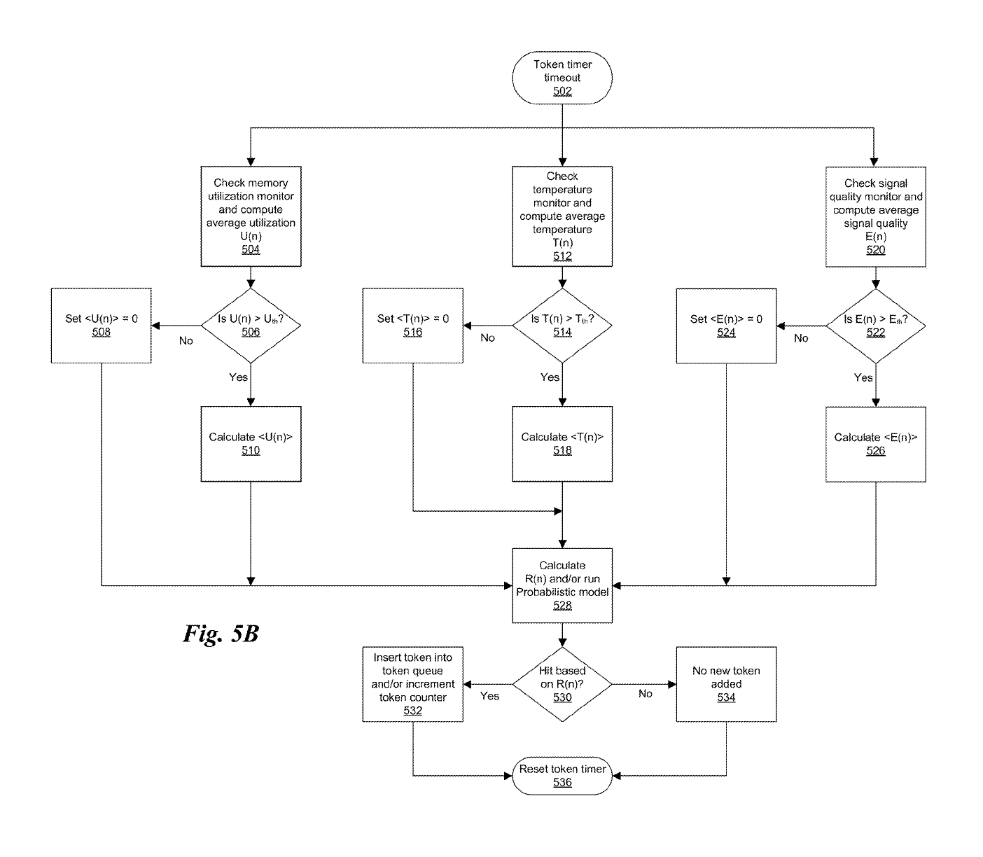

FIG. 5A is a flow diagram illustrating a method for token replenishment according to an embodiment. At block 502, an expiration of the token timer 216 is detected. In response to the detection, the token generator 215 checks the memory utilization monitor 232 at block 504 for memory utilization data and responsively calculates the average memory utilization U(n) over a given time window. Alternatively, the memory utilization monitor 232 performs the calculation for U(n) and provides it to the token generator 215. Once U(n) is calculated or obtained, it is compared with the utilization threshold Uₜₕ at block 506 to determine whether an adverse condition exists due to high memory utilization. If U(n) is less than the utilization threshold, no adverse condition due to memory over-utilization exists. As such, at block 508, the predictor core sets <U(n)> to 0 in accordance to formula (B) above. If, however, the determination at block 506 was that U(n) exceeded the utilization threshold Uₜₕ, then at block 510, <U(n)> is set to

$$\frac{U ( n ) - {U}_{th}}{{U}_{th}}$$

as provided by formula (B).

Next, token generator 215 checks the temperature monitor 252 at block 512 for temperature data and responsively calculates the average temperature T(n) over a given time window. Alternatively, the temperature monitor 252 performs the calculation for T(n) and provides it to the token generator 215. Once T(n) is calculated or obtained, it is compared with the temperature threshold Tₜₕ, at block 514, to determine whether an adverse condition exists due to high temperature. If T(n) is less than the temperature threshold, no adverse condition exists due to temperature. As such, at block 516, the token generator 215 sets <T(n)> to 0 according to formula (B) above. However, if at block 514 it is determined that T(n) is greater than the utilization threshold Tₜₕ, then at block 518, <T(n)> is set to be

$$\frac{T ( n ) - {T}_{th}}{{T}_{th}}$$

in accordance to formula (B).

After determining the existence of adverse condition based on temperature, the token generator 215 next checks the signal quality monitor 242 at block 520 for signal quality data and responsively calculates the average signal quality E(n) over a given time window. Alternatively, the signal quality monitor 242 performs the calculation for E(n) and provides it to the token generator 215. According to an embodiment, the average signal quality E(n) is determined based on the average percentage of DDR eye measurements that pertained to eye distortion over a given time window. Once E(n) is calculated, it is compared with the signal quality threshold Eₜₕ at block 522 to determine whether an adverse condition exists due to poor signal quality. If E(n) is less than the signal quality threshold, then there is no adverse condition due to poor signal quality. As such, at block 524, the token generator 215 sets <E(n)> to 0. However, if, at block 522, it is determined that E(n) is greater than the signal quality threshold Eₜₕ, then at block 526, <E(n)> is set to be

$$\frac{E ( n ) - {E}_{th}}{{E}_{th}} .$$

At block 528, the token generator 215 calculates R(n) based on formula (A) above using the calculated values of <U(n)>, <T(n)>, and <E(n)>. As discussed previously, R(n) is used by the token generator 215 to determine whether or not a token is to be added to the token bucket. According to one embodiment, R(n) is inputted into a probabilistic model which generates a hit or miss based on R(n). At block 530, the result from the probabilistic model is calculated. A hit based on R(n) allows a token to be inserted into the token bucket at block 532, such as adding a token to the token queue or incrementing the token counter by one. A miss means no token is added to the token bucket, as illustrated by block 534. At block 536, the token generation/replenishment is complete and the token timer resets to restart a countdown.

While the token generator 215 in FIG. 5 is shown as a separate component from the predictor core 210, the token generator 215 may be part of the predictor core according to some embodiments. Alternatively, the predictor core 210 could perform the tasks of the token generator such as calculating R(n) and running the probabilistic model for determining whether or not to replenish tokens. Moreover, while the check for adverse conditions based on memory utilization, temperature, and signal quality is performed sequentially in FIG. 5, it is only for illustrative purposes and is by no ways limiting. Any combination, order, and or number of memory utilization, temperature, and signal quality checks may be performed for determining the existence of adverse conditions. For instance, at the expiration of the token timer, token generator 215 or the predictor core 210 may check for the presence of one or two adversities and not necessarily all three. According to other embodiments, the check for adversities may be conducted in parallel, as illustrated by FIG. 5B.

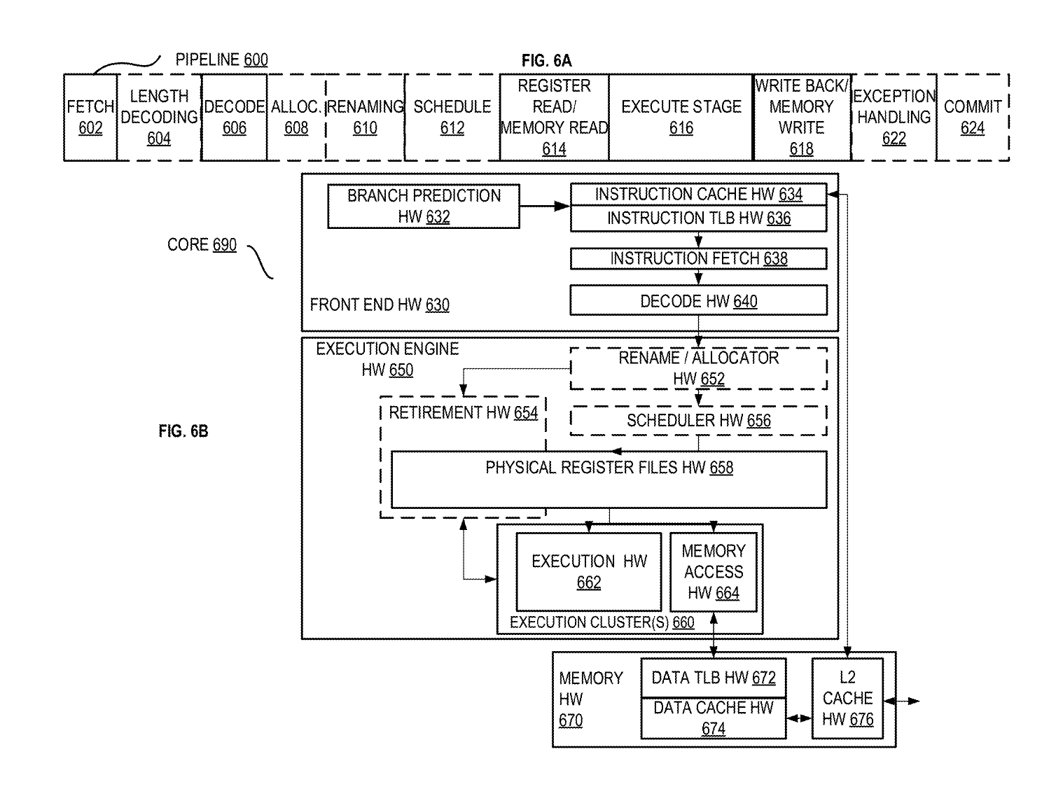

FIG. 6A is a block diagram illustrating both an exemplary in-order pipeline and an exemplary register renaming, out-of-order issue/execution pipeline according to embodiments of the invention. FIG. 6B is a block diagram illustrating both an exemplary embodiment of an in-order architecture core and an exemplary register renaming, out-of-order issue/execution architecture core to be included in a processor according to embodiments of the invention. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end hardware 630 coupled to an execution engine hardware 650, and both are coupled to a memory hardware 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end hardware 630 includes a branch prediction hardware 632 coupled to an instruction cache hardware 634, which is coupled to an instruction translation lookaside buffer (TLB) 636, which is coupled to an instruction fetch hardware 638, which is coupled to a decode hardware 640. The decode hardware 640 (or decoder) may decode instructions, and generate as an output one or more micro-operations, micro-code entry points, microinstructions, other instructions, or other control signals, which are decoded from, or which otherwise reflect, or are derived from, the original instructions. The decode hardware 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode hardware 640 or otherwise within the front end hardware 630). The decode hardware 640 is coupled to a rename/allocator hardware 652 in the execution engine hardware 650.

The execution engine hardware 650 includes the rename/allocator hardware 652 coupled to a retirement hardware 654 and a set of one or more scheduler hardware 656. The scheduler hardware 656 represents any number of different schedulers, including reservations stations, central instruction window, etc. The scheduler hardware 656 is coupled to the physical register file(s) hardware 658. Each of the physical register file(s) hardware 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) hardware 658 comprises a vector registers hardware, a write mask registers hardware, and a scalar registers hardware. These register hardware may provide architectural vector registers, vector mask registers, and general purpose registers. The physical register file(s) hardware 658 is overlapped by the retirement hardware 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement hardware 654 and the physical register file(s) hardware 658 are coupled to the execution cluster(s) 660. The execution cluster(s) 660 includes a set of one or more execution hardware 662 and a set of one or more memory access hardware 664. The execution hardware 662 may perform various operations (e.g., shifts, addition, subtraction, multiplication) and on various types of data (e.g., scalar floating point, packed integer, packed floating point, vector integer, vector floating point). While some embodiments may include a number of execution hardware dedicated to specific functions or sets of functions, other embodiments may include only one execution hardware or multiple execution hardware that all perform all functions. The scheduler hardware 656, physical register file(s) hardware 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler hardware, physical register file(s) hardware, and/or execution cluster—and in the case of a separate memory access pipeline, certain embodiments are implemented in which only the execution cluster of this pipeline has the memory access hardware 664). It should also be understood that where separate pipelines are used, one or more of these pipelines may be out-of-order issue/execution and the rest in-order.

The set of memory access hardware 664 is coupled to the memory hardware 670, which includes a data TLB hardware 672 coupled to a data cache hardware 674 coupled to a level 2 (L2) cache hardware 676. In one exemplary embodiment, the memory access hardware 664 may include a load hardware, a store address hardware, and a store data hardware, each of which is coupled to the data TLB hardware 672 in the memory hardware 670. The instruction cache hardware 634 is further coupled to a level 2 (L2) cache hardware 676 in the memory hardware 670. The L2 cache hardware 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode hardware 640 performs the decode stage 606; 3) the rename/allocator hardware 652 performs the allocation stage 608 and renaming stage 610; 4) the scheduler hardware 656 performs the schedule stage 612; 5) the physical register file(s) hardware 658 and the memory hardware 670 perform the register read/memory read stage 614; the execution cluster 660 perform the execute stage 616; 6) the memory hardware 670 and the physical register file(s) hardware 658 perform the write back/memory write stage 618; 7) various hardware may be involved in the exception handling stage 622; and 8) the retirement hardware 654 and the physical register file(s) hardware 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 690 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache hardware 634/674 and a shared L2 cache hardware 676, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

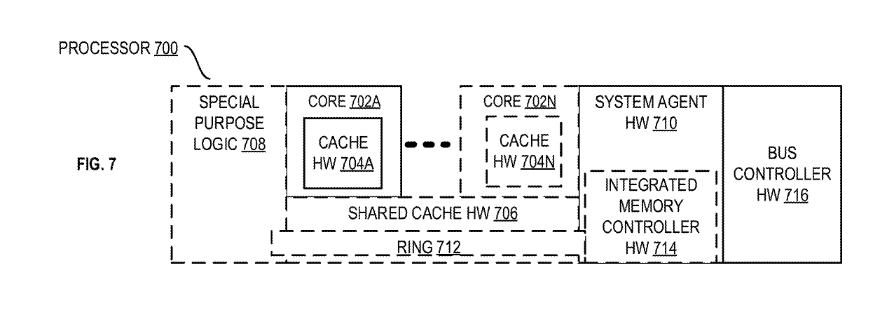

FIG. 7 is a block diagram of a processor 700 that may have more than one core, may have an integrated memory controller, and may have integrated graphics according to embodiments of the invention. The solid lined boxes in FIG. 7 illustrate a processor 700 with a single core 702A, a system agent 710, a set of one or more bus controller hardware 716, while the optional addition of the dashed lined boxes illustrates an alternative processor 700 with multiple cores 702A-N, a set of one or more integrated memory controller hardware 714 in the system agent hardware 710, and special purpose logic 708.

Thus, different implementations of the processor 700 may include: 1) a CPU with the special purpose logic 708 being integrated graphics and/or scientific (throughput) logic (which may include one or more cores), and the cores 702A-N being one or more general purpose cores (e.g., general purpose in-order cores, general purpose out-of-order cores, a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache hardware 706, and external memory (not shown) coupled to the set of integrated memory controller hardware 714. The set of shared cache hardware 706 may include one or more mid-level caches, such as level 2 (L2), level 3 (L3), level 4 (L4), or other levels of cache, a last level cache (LLC), and/or combinations thereof. While in one embodiment a ring based interconnect hardware 712 interconnects the integrated graphics logic 708, the set of shared cache hardware 706, and the system agent hardware 710/integrated memory controller hardware 714, alternative embodiments may use any number of well-known techniques for interconnecting such hardware. In one embodiment, coherency is maintained between one or more cache hardware 706 and cores 702-A-N.

In some embodiments, one or more of the cores 702A-N are capable of multi-threading. The system agent 710 includes those components coordinating and operating cores 702A-N. The system agent hardware 710 may include for example a power control unit (PCU) and a display hardware. The PCU may be or include logic and components needed for regulating the power state of the cores 702A-N and the integrated graphics logic 708. The display hardware is for driving one or more externally connected displays.

The cores 702A-N may be homogenous or heterogeneous in terms of architecture instruction set; that is, two or more of the cores 702A-N may be capable of execution the same instruction set, while others may be capable of executing only a subset of that instruction set or a different instruction set. In one embodiment, the cores 702A-N are heterogeneous and include both the “small” cores and “big” cores described below.

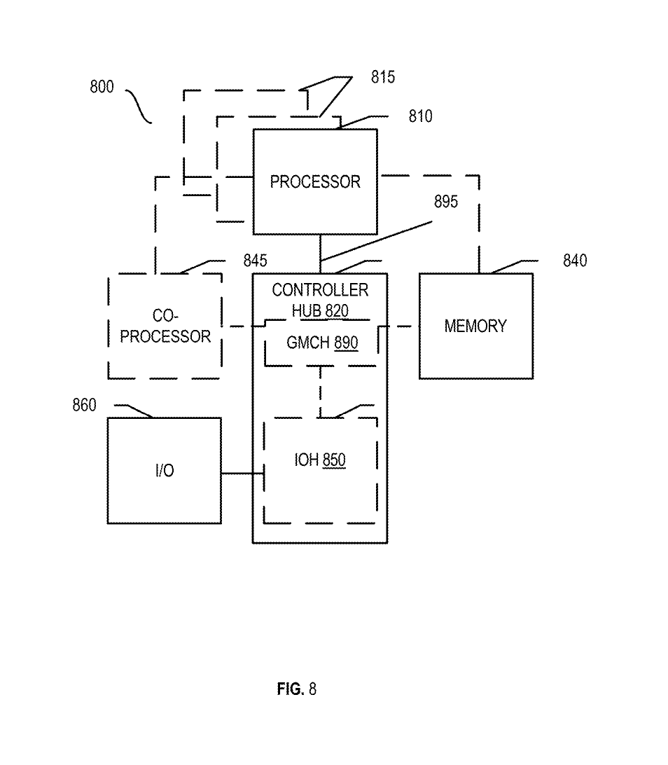

FIGS. 8-11 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 8, shown is a block diagram of a system 800 in accordance with one embodiment of the present invention. The system 800 may include one or more processors 810, 815, which are coupled to a controller hub 820. In one embodiment the controller hub 820 includes a graphics memory controller hub (GMCH) 890 and an Input/Output Hub (IOH) 850 (which may be on separate chips); the GMCH 890 includes memory and graphics controllers to which are coupled memory 840 and a coprocessor 845; the IOH 850 is couples input/output (I/O) devices 860 to the GMCH 890. Alternatively, one or both of the memory and graphics controllers are integrated within the processor (as described herein), the memory 840 and the coprocessor 845 are coupled directly to the processor 810, and the controller hub 820 in a single chip with the IOH 850.

The optional nature of additional processors 815 is denoted in FIG. 8 with broken lines. Each processor 810, 815 may include one or more of the processing cores described herein and may be some version of the processor 700.

The memory 840 may be, for example, dynamic random access memory (DRAM), phase change memory (PCM), or a combination of the two. For at least one embodiment, the controller hub 820 communicates with the processor(s) 810, 815 via a multi-drop bus, such as a frontside bus (FSB), point-to-point interface, or similar connection 895.

In one embodiment, the coprocessor 845 is a special-purpose processor, such as, for example, a high-throughput MIC processor, a network or communication processor, compression engine, graphics processor, GPGPU, embedded processor, or the like. In one embodiment, controller hub 820 may include an integrated graphics accelerator.

There can be a variety of differences between the physical resources 810, 815 in terms of a spectrum of metrics of merit including architectural, microarchitectural, thermal, power consumption characteristics, and the like.

In one embodiment, the processor 810 executes instructions that control data processing operations of a general type. Embedded within the instructions may be coprocessor instructions. The processor 810 recognizes these coprocessor instructions as being of a type that should be executed by the attached coprocessor 845. Accordingly, the processor 810 issues these coprocessor instructions (or control signals representing coprocessor instructions) on a coprocessor bus or other interconnect, to coprocessor 845. Coprocessor(s) 845 accept and execute the received coprocessor instructions.

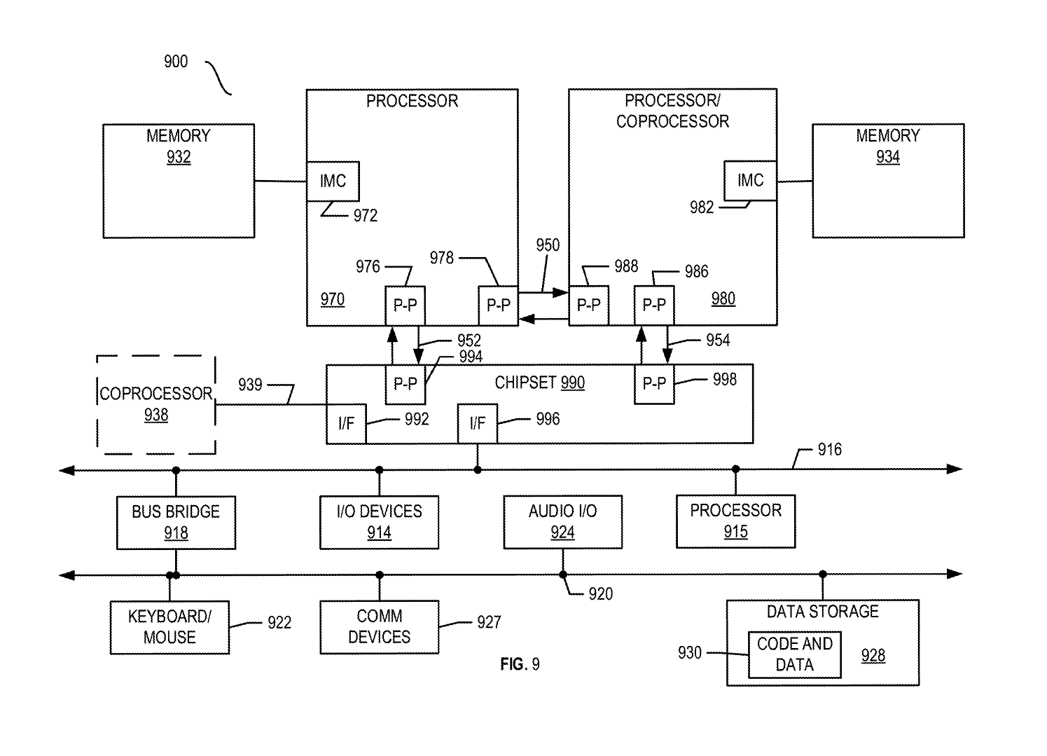

Referring now to FIG. 9, shown is a block diagram of a first more specific exemplary system 900 in accordance with an embodiment of the present invention. As shown in FIG. 9, multiprocessor system 900 is a point-to-point interconnect system, and includes a first processor 970 and a second processor 980 coupled via a point-to-point interconnect 950. Each of processors 970 and 980 may be some version of the processor 700. In one embodiment of the invention, processors 970 and 980 are respectively processors 810 and 815, while coprocessor 938 is coprocessor 845. In another embodiment, processors 970 and 980 are respectively processor 810 coprocessor 845.

Processors 970 and 980 are shown including integrated memory controller (IMC) hardware 972 and 982, respectively. Processor 970 also includes as part of its bus controller hardware point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may optionally exchange information with the coprocessor 938 via a high-performance interface 939. In one embodiment, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCI Express bus or another third generation I/O interconnect bus, although the scope of the present invention is not so limited.

As shown in FIG. 9, various I/O devices 914 may be coupled to first bus 916, along with a bus bridge 918 which couples first bus 916 to a second bus 920. In one embodiment, one or more additional processor(s) 915, such as coprocessors, high-throughput MIC processors, GPGPU's, accelerators (such as, e.g., graphics accelerators or digital signal processing (DSP) hardware), field programmable gate arrays, or any other processor, are coupled to first bus 916. In one embodiment, second bus 920 may be a low pin count (LPC) bus. Various devices may be coupled to a second bus 920 including, for example, a keyboard and/or mouse 922, communication devices 927 and a storage hardware 928 such as a disk drive or other mass storage device which may include instructions/code and data 930, in one embodiment. Further, an audio I/O 924 may be coupled to the second bus 920. Note that other architectures are possible. For example, instead of the point-to-point architecture of FIG. 9, a system may implement a multi-drop bus or other such architecture.

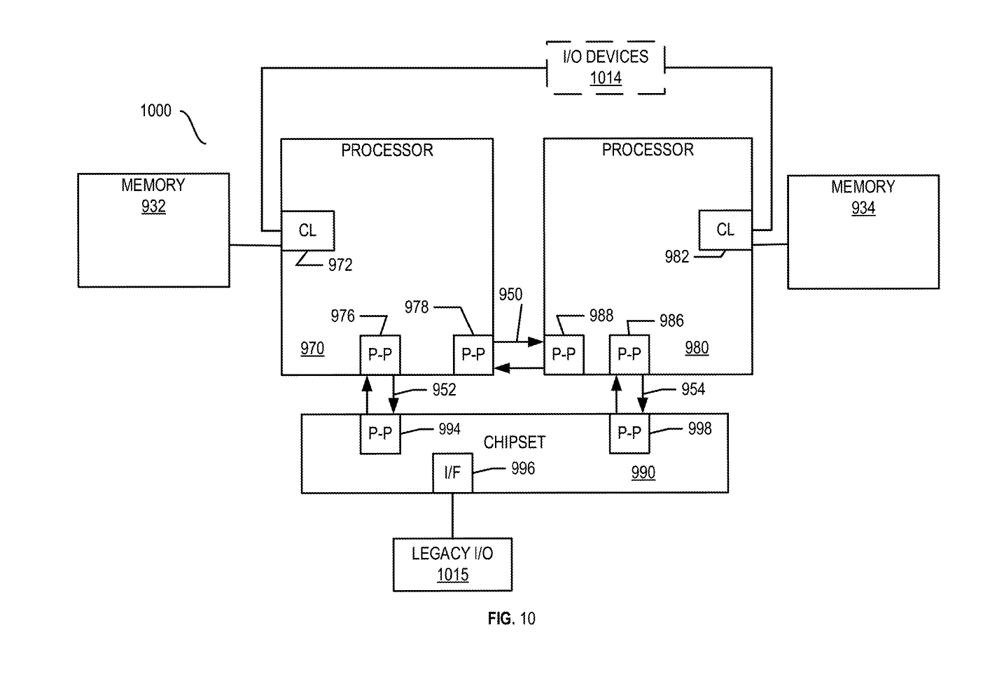

Referring now to FIG. 10, shown is a block diagram of a second more specific exemplary system 1000 in accordance with an embodiment of the present invention. Like elements in FIGS. 9 and 10 bear like reference numerals, and certain aspects of FIG. 9 have been omitted from FIG. 10 in order to avoid obscuring other aspects of FIG. 10.

FIG. 10 illustrates that the processors 970, 980 may include integrated memory and I/O control logic (“CL”) 972 and 982, respectively. Thus, the CL 972, 982 include integrated memory controller hardware and include I/O control logic. FIG. 10 illustrates that not only are the memories 932, 934 coupled to the CL 972, 982, but also that I/O devices 1014 are also coupled to the control logic 972, 982. Legacy I/O devices 1015 are coupled to the chipset 990.

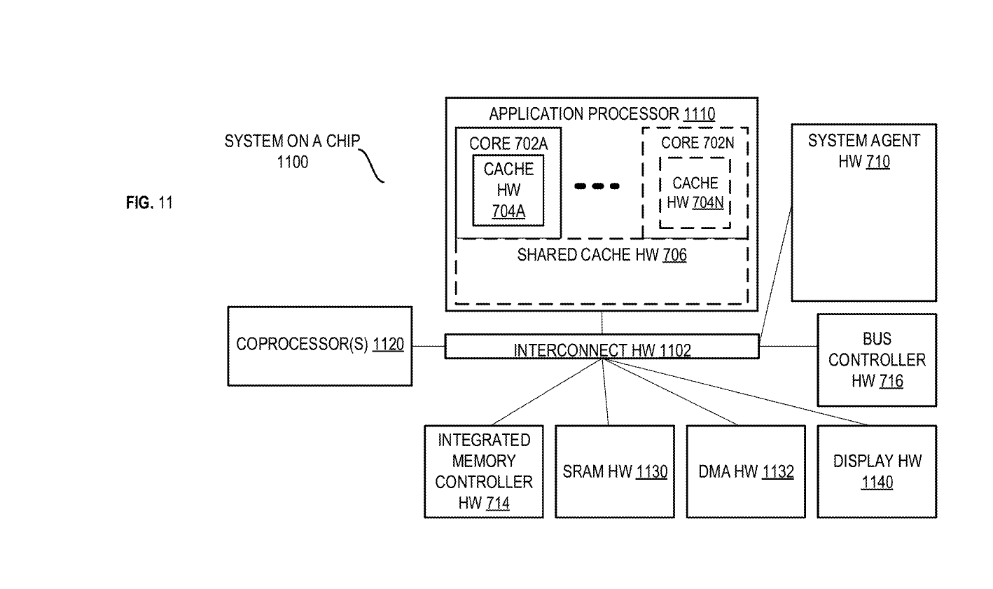

Referring now to FIG. 11, shown is a block diagram of a SoC 1100 in accordance with an embodiment of the present invention. Similar elements in FIG. 7 bear like reference numerals. Also, dashed lined boxes are optional features on more advanced SoCs. In FIG. 11, an interconnect hardware 1102 is coupled to: an application processor 1110 which includes a set of one or more cores 702A-N and shared cache hardware 706; a system agent hardware 710; a bus controller hardware 716; an integrated memory controller hardware 714; a set or one or more coprocessors 1120 which may include integrated graphics logic, an image processor, an audio processor, and a video processor; an static random access memory (SRAM) hardware 1130; a direct memory access (DMA) hardware 1132; and a display hardware 1140 for coupling to one or more external displays. In one embodiment, the coprocessor(s) 1120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 930 illustrated in FIG. 9, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

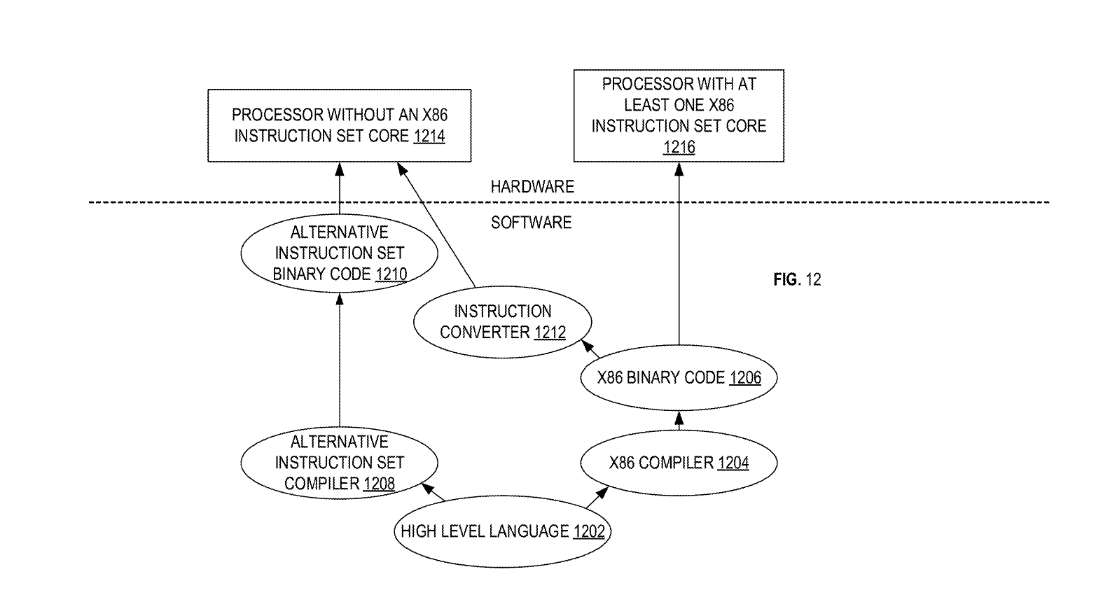

FIG. 12 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 12 shows a program in a high level language 1202 may be compiled using an x86 compiler 1204 to generate x86 binary code 1206 that may be natively executed by a processor with at least one x86 instruction set core 1216. The processor with at least one x86 instruction set core 1216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1204 represents a compiler that is operable to generate x86 binary code 1206 (e.g., object code) that can, with or without additional linkage processing, be executed on the processor with at least one x86 instruction set core 1216. Similarly, FIG. 12 shows the program in the high level language 1202 may be compiled using an alternative instruction set compiler 1208 to generate alternative instruction set binary code 1210 that may be natively executed by a processor without at least one x86 instruction set core 1214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1212 is used to convert the x86 binary code 1206 into code that may be natively executed by the processor without an x86 instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have an x86 instruction set processor or core to execute the x86 binary code 1206.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

1.-25. (canceled)

26. A method comprising:
tracking one or more corrected memory errors (CEs) in a memory;
tracking one or more generated tokens, wherein the tokens are being generated at an initial rate;
detecting one or more adverse conditions being subjected to the memory and responsive to the detection, reduce the rate at which the tokens are being generated;
decrementing the tracked CEs based on a reoccurring leak timer, wherein upon each expiration of the reoccurring leak timer, the tracked CEs is decremented by one so long as there is at least one tracked token;
reducing the tracked tokens by one in response to every decrement of the tracked CE; and
triggering a CE overflow signal upon detecting a count of the tracked CEs exceeding an overflow limit.

27. The method of claim 26, wherein detecting the one or more adverse conditions being subjected to the memory further comprises:
detecting an indication of memory utilization exceeding a utilization threshold;

28. The method of claim 26, wherein detecting the one or more adverse conditions being subjected to the memory further comprises:
detecting an indication of memory signal quality falling below a signal quality threshold;

29. The method of claim 26, wherein detecting the one or more adverse conditions being subjected to the memory further comprises:
detecting an indication of memory temperature exceeding a temperature threshold;

30. The method of claim 26, wherein the reduced rate at which the tokens are being generated is determined based on a default CE leakage rate, as determined based on the reoccurring leak timer, and one or more indicators of the one or more adverse conditions.

31. The method of claim 30, wherein the one or more indicators of the one or more adverse conditions comprise the difference between average memory utilization in a given time period and a utilization threshold.

32. The method of claim 30, wherein the one or more indicators of the one or more adverse conditions comprise the difference between average memory signal quality in a given time period and a signal quality threshold.

33. The method of claim 30, wherein the one or more indicators of the one or more adverse conditions comprise the difference between average temperature in a given time period and a temperature threshold.

34. The method of claim 26, further comprising:
resetting the rate at which the tokens are being generated back to the initial rate upon detecting an absence of adverse conditions being subjected to the memory.

35. The method of claim 26, wherein the one or more corrected memory errors (CEs) in the memory comprises one or more internal memory data corruptions corrected by error correction code (ECC).

36. A system comprising:
a memory;
a CE counter to track one or more corrected memory errors (CEs) in the memory;
a token generator;
a token counter to track one or more tokens generated by the token generator, wherein the tokens are being generated at an initial rate;
one or more adverse condition detectors to detect one or more adverse conditions being subjected to the memory and responsive to the detection, the token generator to reduce the rate at which the tokens are being generated;
a hardware predictor core to:
decrement the CE counter based on a reoccurring leak timer, wherein upon each expiration of the reoccurring leak timer, the hardware predictor core to decrement the CE counter by one so long as there is at least one tracked token;
reduce the tracked tokens by one in response to every decrement of the tracked CEs; and
trigger a CE overflow signal upon detecting a count of the tracked CEs exceeding an overflow limit.

37. The system of claim 36, wherein to detect the one or more adverse conditions being subjected to the memory further comprises:
detecting an indication of memory utilization exceeding a utilization threshold;

38. The system of claim 36, wherein to detect the one or more adverse conditions being subjected to the memory further comprises:
detecting an indication of memory signal quality falling below a signal quality threshold;

39. The system of claim 36, wherein to detect the one or more adverse conditions being subjected to the memory further comprises:
detecting an indication of memory temperature that exceeding a temperature threshold;

40. The system of claim 36, wherein the reduced rate at which the tokens are being generated is determined based on a default CE leakage rate, as determined based on the reoccurring leak timer, and one or more indicators of the one or more adverse conditions.

41. The system of claim 40, wherein the one or more indicators of the one or more adverse conditions comprise the difference between average memory utilization in a given time period and a utilization threshold.

42. The system of claim 40, wherein the one or more indicators of the one or more adverse conditions comprise the difference between average memory signal quality in a given time period and a signal quality threshold.

43. The system of claim 40, wherein the one or more indicators of the one or more adverse conditions comprise the difference between average temperature in a given time period and a temperature threshold.

44. The system of claim 36, wherein the token generator to reset the rate at which the tokens are being generated back to the initial rate upon the one or more adverse condition detectors detecting an absence of adverse conditions being subjected to the memory.

45. The system of claim 36, wherein the one or more corrected memory errors (CEs) in the memory comprises one or more internal memory data corruptions corrected by error correction code (ECC).

46. A apparatus comprising:
a corrected memory error (CE) counter to track one or more corrected memory errors in a memory;
a token counter to track one or more tokens generated by a token generator, wherein the tokens are being generated at an initial rate;
one or more adverse condition detectors to detect one or more adverse conditions being subjected to the memory and responsive to the detection, the token generator to reduce the rate at which the tokens are being generated;
a hardware predictor core to:
decrement the CE counter based on a reoccurring leak timer, wherein upon each expiration of the reoccurring leak timer, the hardware predictor core to decrement the CE counter by one so long as there is at least one tracked token;
reduce the tracked tokens by one in response to every decrement of the tracked CEs; and
trigger a CE overflow signal upon detecting a count of the tracked CEs exceeding an overflow limit.

47. The apparatus of claim 46, wherein to detect the one or more adverse conditions being subjected to the memory further comprises:
detecting an indication of memory utilization exceeding a utilization threshold;

48. The apparatus of claim 46, wherein to detect the one or more adverse conditions being subjected to the memory further comprises:
detecting an indication of memory signal quality falling below a signal quality threshold;

49. The apparatus of claim 46, wherein to detect the one or more adverse conditions being subjected to the memory further comprises:
detecting an indication of memory temperature that exceeding a temperature threshold;

50. The apparatus of claim 46, wherein the reduced rate at which the tokens are being generated is determined based on a default CE leakage rate, as determined based on the reoccurring leak timer, and one or more indicators of the one or more adverse conditions.
